(19) United States
(12) Patent Application Publication
(10) Pub. No.: US 2002/0167942 A1
(43) Pub. Date: Nov. 14, 2002

(54) Server-site response time computation for arbitrary applications

(76) Inventor: Cathy Fulton, Austin, TX (US)

Correspondence Address: JOHNSON & ASSOCIATES, PO BOX 90698, AUSTIN, TX, 78709-0698, US

(21) Appl. No.: 10/138,785

(22) Filed: May 3, 2002

Related U.S. Application Data
(60) Provisional application No. 60/288,728, filed on May 4, 2001.

(51) Int. Cl. H04J 3/06

(52) U.S. Cl. 370/352; 370/503

(57) ABSTRACT

A system is provided for monitoring response-time behavior of arbitrary applications. The system provides packet-level and transaction-level response times. The response time delay is separated into network and server components to identify bottlenecks. The network delay component can be updated using continual innovations. Response time computations are based on the actual application from any desired clients.

### CROSS REFERENCE TO RELATED APPLICATIONS

This application claims priority under 35 U.S.C. § 120 to co-pending, commonly owned U.S. provisional patent application serial No. 60/288,728 filed on May 4, 2001, entitled SERVER-SITE RESPONSE TIME COMPUTATION FOR ARBITRARY APPLICATIONS, which is incorporated by reference herein.

### FIELD OF THE INVENTION

This invention relates to a method for determining the time required for communication between a computer server and a client.

### BACKGROUND OF THE INVENTION

Network and MIS managers are motivated to keep business-critical applications running smoothly across the networks separating servers from end-users. They would like to be able to monitor response time behavior experienced by the users, and to clearly identify potential network and server bottlenecks as quickly as possible. They would also like the management/maintenance of the monitoring system to have a low man-hour cost due to the critical shortage of human expertise. It is desired that the information be consistently reliable, with few false positives (else the alarms will be ignored) and few false negatives (else problems will not be noticed quickly).

Existing response-time monitoring solutions fall into one of three main categories: those requiring a client-site agent (an agent located near the client, on the same site as the client); subscription service; and solutions for specialized applications only. These existing solutions are briefly described below.

There are several existing response-time monitoring tools (e.g., NetIQ's Pegasus and Compuware's Ecoscope) that require a hardware and/or software agent be installed near each client site from which end-to-end or total response times are to be computed. The main problem with this approach is that it can be difficult or impossible to get the agents installed and keep them operating. For a global network, the number of agents can be significant; installation can be slow and maintenance painful. For an eCommerce site, installation of the agents is not practical; requesting potential customers to install software on their computers probably would not meet with much success. A secondary issue with this approach is that each of the client-site agents must upload their measurements to a centralized management platform; this adds unnecessary traffic on what may be expensive wide-area links. A third issue with this approach is that it is difficult to accurately separate the network from server delay contributions.

To overcome the issue with numerous agent installs, some companies (e.g., KeyNotes and Mercury Interactive) offer a subscription service whereby one may use their preinstalled agents for response-time monitoring. There are two main problems with this approach. One is that the agents are not monitoring “real” client traffic but are artificially generating a handful of “defined” transactions. The other is that the monitoring does not generally cover the full range of client sites—the monitoring is limited to where the service provider has installed agents.

A third approach used by a few companies (Luminate) is to provide a monitoring solution via a server-site agent (an agent located near the server, on the same site as the server), rather than a client-site agent. The shortcoming with these existing tools is that they either support only a single application (e.g., SAP/R3 or web), or that they are using generated Internet control message protocol (ICMP) packets rather than the actual client application packets to estimate network response times, or that they assume a constant network response time throughout the life of a TCP session. The ICMP packets may be treated very different than the actual client application packets because of their protocol (separate management queue and/or QoS policy), their size (serialization and/or scheduling discipline), and their timing (not sent at same time as the application packets). Network response times typically vary considerably throughout a TCP session.

It can therefore be seen that there is a need for a server-site response time computation methodology that overcomes problems found in the prior art.

### SUMMARY OF THE INVENTION

A method of the invention is provided for determining response times in a network without relying on client-site agents comprising the steps of: providing a server-site agent; measuring the server delay; estimating the network delay; and determining the response time of a client on the network based on the measured server delay and the estimated network delay.

One embodiment of the invention provides a server-site monitoring system for determining response-time behavior for arbitrary applications comprising: a server-site agent, wherein the server-site agent performs the processing steps of, determining application response times, and separating determined response times into network delay components and server delay components.

One embodiment of the invention provides a method of determining response times in a WAN without requiring multiple agents comprising the steps of: providing an agent somewhere on the WAN; and for one or more transactions on the WAN, determining the end-to-end response time, the server delay, and the network delay.

One embodiment of the invention provides a method of determining transaction-level response times in a network comprising the steps of: for a transaction comprised of a plurality of individual components, tracking the response times of each of the individual components; and determining the response time of the transaction by reconstructing the transaction using the tracked response times of the individual components.

One embodiment of the invention provides a method of determining the response time of a transaction in a network comprising the steps of: deriving a mathematical expression to define a transaction that is comprised of a sequence of requests and responses; determining packet-level response times of the sequence of requests and responses; reconstructing the transaction based on the derived mathematical expression and the packet-level response times.

One embodiment of the invention provides a method of estimating a network delay in a network comprising the steps of: (A) providing a server-site agent; (B) determining the amount of time from when a server sends a response to a client, to when the server receives an acknowledgment back from the client; (C) estimating the network delay based on the determined amount of time; and (D) repeating steps (B) and (C) to improve the accuracy of estimation of the network delay where the network delay is not constant.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 shows a client communicating with a server across a network.

FIG. 2 shows network packet flow between a client and a server.

FIG. 3 illustrates techniques for computing packet-level response times for arbitrary TCP/IP applications.

FIG. 4 is a flow chart illustrating the functionality of the real-time response-time computation engine.

FIG. 5 is a flow chart illustrating the functionality of the near-real-time transaction reconstruction engine.

### DETAILED DESCRIPTION

Briefly, the present invention is a server-site monitoring process that reports response-time behavior for arbitrary applications. With the present invention, there is no need to deploy agents at client sites, although the invention does support this configuration. If agents are deployed both at server and client sites, it will correlate the information for improved accuracy. The server-site deployment greatly reduces administration and management issues.

The solution of the present invention supports any arbitrary application; it is not restricted to specific applications like hypertext transfer protocol (HTTP) or SAP. The invention provides packet-level response times automatically as well as transaction-level response times upon transaction definition. The transaction-level response times are obtained using a reconstruction process. The response time delay is separated into network and server components (in addition to other delay metrics such as Application Transfer Delay and Retransmission Delay) to clearly identify bottlenecks. The network delay component is updated using continual innovations. The response time computations are based on the actual application (rather than an emulated application or ICMP) from each and all clients desired (not just where subscription agents are located). For reliable applications, the continual innovations to network delay are computed for each client acknowledgement. For unreliable applications, the continual innovations to network delay are achieved using emulated application packets coupled with connection set-up times.

The solution of the present invention recognizes that the response size is an important parameter for determining acceptable performance. For example, a user that requests a 100 MByte download should naturally experience a longer response time than one who requests a 100 KByte download. The response time measurements and alarms are thus separated based on size of the response.

To better understand the present invention, the invention will be described in the context of a client communicating with a server across a network. Following is a background explanation of response time in a network environment, in which the present invention may be used.

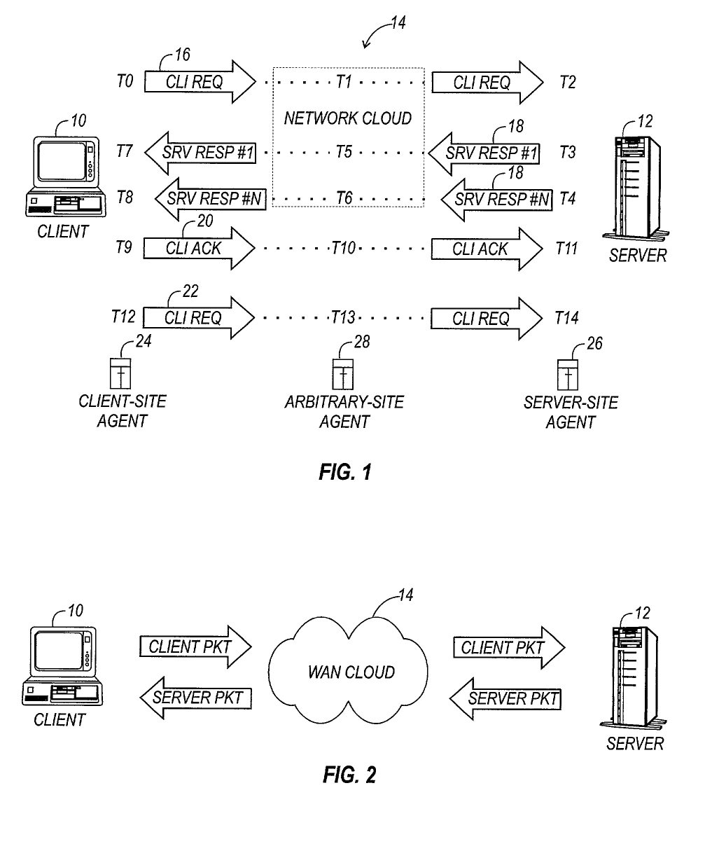

FIG. 1 shows a client 10 communicating with a server 12 across a network 14. The client 10 sends a request 16 to the server 12, and the server responds with one or more response packets 18. If it is a reliable application using positive acknowledgments, the client acknowledges receipt of the response message with an acknowledgment 20. The client may then send another request 22 to the server. In general, a transaction (e.g., clicking a URL on a web page, placing an order, performing a query, etc.) may consist of a number of client requests and corresponding server responses. In FIG. 1, various times are designated by T0 through T14. The following times can be defined as follows:

Total 1st-Response Time: T7-T0

Total Response Time: T8-T0

Server Processing Delay (Lower Bound): T3-T2

Server Processing Delay (Upper Bound): T4-T2

Application Transfer Delay: T4-T3

Network Delay: T2-T0+T8-T4

Total Response Time=Server Processing Delay (Upper Bound)+Network Delay

Total Response Time=Server Processing Delay (Lower Bound)+Application

Transfer Delay+Network Delay

Client Think Time: T12-T8

Request Interarrival Time: T12-T0

In general, the client request 16 may arrive over a time duration rather than at an instance in time (e.g., the client request consists of multiple packets). In this event, time T2 represents the arrival time of the end of the request but the duration of the request arrival must also be added to the Total Response Time.

For applications written using the application response measurement (ARM) application program interface (API), the application explicitly identifies the components of its transactions. For well-understood applications, packet filter pattern matching may be used to identify the different components of the transaction flow: beginning, middle, conclusion, and acknowledgments. For arbitrary transmission control protocol (TCP) applications, the transaction may be defined on a packet level. Transaction-level response times are replaced by packet-level response times. Client requests are identified as packets from the client that contain data (non-zero TCP LENGTH field). Server responses are identified as packets from the server that contain data (non-zero TCP LENGTH field). Requests are matched to responses by TCP SEQUENCE and ACKNOWLEDGMENT fields in conjunction with timing information. As an illustration: The TCP protocol requires that packets be acknowledged by placing an appropriate value in the ACKNOWLEDGMENT field of a response packet. This value is determined by adding the number of payload bytes in the requesting packet to the requesting packet's SEQUENCE number. In addition to this, if the SYN or FIN flag is set in the requesting packet, the acknowledging value must be incremented by one. Whenever a data packet is observed, one can allocate a data structure, called an Open MiniTransaction, that contains (among other things) the time at which the packet was detected and the value that the other host will use to acknowledge receipt of the packet. Whenever an acknowledging packet is observed, its ACKNOWLEDGMENT field is compared to the expected acknowledgment values in the existing Open MiniTransaction data structures. When a match is detected, then the time at which the data packet was observed is subtracted from the time at which the acknowledging packet was observed and the difference is taken to be the minitransaction time. If the initial minitransaction data packet originated from the server host, then the minitransaction time is taken to be the network round trip time. If the minitransaction data packet originated from the client host, then the minitransaction time is taken to be the server processing time.

Referring again to FIG. 1, the time elapsed from when the client sends the request 16 (packet-level or transaction-level) to when it receives the last packet in the response 18, is referred to as the Total Response Time (T8-T0). This response time consists of server processing delay and network delay. The server processing delay is hard to clearly identify for arbitrary applications, but it can be bounded. A lower bound on the server processing delay is the time from when the server receives the client request 16 to when it transmits the first data packet in the response message 18 (T3-T2). This Server Processing Delay (Lower Bound) may differ significantly from the true server processing delay if the server sends out preliminary information (e.g., “Please wait while I process your request” messages) before fully processing the request. An upper bound on the server processing delay is the time from when the server receives the client request 16 to when it transmits the last packet in the response message 18 (T4-T2). This Server Processing Delay (Upper Bound) may include significant network delay due to protocol windowing and retransmissions. Identification of this timing information is important for bottleneck identification and network/application planning. The difference between the Server Processing Delay (Upper Bound) and Server Processing Delay (Lower Bound) is the Application Transfer Delay.

Agents may be used to collect timing information on the application at various locations on the network. In general, the agents can only note times as packets pass them. For example in FIG. 1, an agent 24 located at the client 10 can only observe times T0, T7, T8, T9 and T12. An agent 26 located at the server 12 can only observe times T2, T3, T4, T11 and T14. An agent 28 located along the wide area network (WAN) 14 can only observe times T1, T5, T6, T10 and T13 (assuming the application packets are routed past the WAN agent 28 in both directions).

A client-site agent 24 can accurately compute the total response times, but it has difficulty identifying the server processing and network delay components. One common identification method used in commercial agents is to assign the network delay equal to the TCP session setup time. This method is based on two assumptions: server processing is negligible during session setup (often reasonable) and network delay is constant throughout the session (reasonable only when sessions are very short). Some applications, particularly those based on Telnet and file transfer protocol (ftp), may keep a session open for hours. The keep-alive option in HTTP, coupled with dynamic web sites, result in longer web sessions than in the past. Given the bursty nature of network traffic, it is unrealistic to assume constant network delay throughout a session. Network delay computation on the client side requires the assumption that the delay is constant over some time period, when in fact network delay can vary dramatically over small time intervals.

An agent 28 located somewhere along the client-server and server-client path can record the arrival times of passing packets. The agent 28 can determine the time elapsed from when it intercepts the client request 16, to when it receives the first and last (and all between) server responses 18. These times are respectively referred to as the “1st Agent=>Server=>Agent” and the “Last Agent=>Server=>Agent” response times. If the agent 28 were located near the client 10, then the “Last Agent=>Server=>Agent” response time would be nearly equivalent to the Total Response Time. If the agent 28 were separate from the client 10, the two statistics would also differ by the time required for the client request 16 to traverse from client 10 to the agent 28 plus the time required for the last response packet 18 to travel from the agent 28 to the client 10. In essence, the total and “Last Agent=>Server=>Agent” response times differ by a round-trip network delay between the client 10 and agent 28.

An agent 28 can provide an estimate of this round-trip “Client=>Agent=>Client” network delay by computing the time elapsed from when the agent 28 intercepts a server response packet 18 to when it detects the associated client acknowledgment 20 for reliable applications. This estimate is referred to as the “1st Agent=>Client=>Agent” response time. The estimate differs from the actual time in that it uses the transmission time of an acknowledgment 20 rather than the request packet 16 from client to probe. For unreliable applications, application probe packets (e.g., a TCP SYN/connection request packet using the same TCP port as the application) coupled with session times may be used as an estimator.

A server-site agent 26 can accurately compute the server delays (T3-T2 and T4-T2 in FIG. 1), but it must use some method to approximate the network delay and total response times. The network delay may be estimated as described above (T11-T4 in FIG. 1). The total response time is a random variable that is the sum of two other random variables: Server 1st-Response Processing Delay T3-T2 and mixed delay T11-T3 (note that the server total delay T4-T2 will in general include network delay due to retransmissions and protocol windowing). Given that the two addendums can be treated as independent—which is a very reasonable assumption, the distribution of the total response time can be found from the convolution of the addendums' response time distributions. The underestimation of the round-trip client-agent delay due to packet size differential should typically have negligible impact on the total response time statistic when the latter is sufficiently large to be of any interest. This delay difference can be estimated, and thus corrected, by computing the serialization delays due to the size differential along the network path.

The computation of the packet-level response times is based on information stored in the TCP and IP packet headers. Thus it can be used with arbitrary TCP/IP applications. Another metric of interest is the transaction-level response times, where a transaction may consist of one or more client requests. For example, consider a user browsing the web. The user clicks on a URL that results in five client request packets (one for the text and one for each of the four images on the page) being sent to the server. The transaction response time might be the elapsed time from when the user clicks the URL to when the page has completed loading. This transaction would have five associated and possibly overlapping packet response times. Consider a user placing an order via the web. The user may have to click several URLs to enter their billing and shipping and request information. The transaction response time might be the elapsed time from when the user begins entering personal information to when the order placement was completed (which may involve client think time). A transaction may be defined in many different manners depending on the objective. In the last example, the meta transaction was defined to include client entry time. Another meta transaction might be defined that subtracts out the client entry or think time. Another transaction might be defined as a single form in the order placement process.

Users tend to think in terms of transactions, not packets. However, it is difficult to define and measure transactions for arbitrary applications running on a production network. Pattern matching filters for specific transactions may be used to identify the transaction components. Certain protocols may be easily decoded to identify the request and response packets. The approach of the present invention consists of using pattern matching/protocol decodes for known applications and the packet-level approach described above for arbitrary TCP/IP applications. Transaction-level response times are achieved for defined transactions by using the transaction reconstruction method of the present invention.

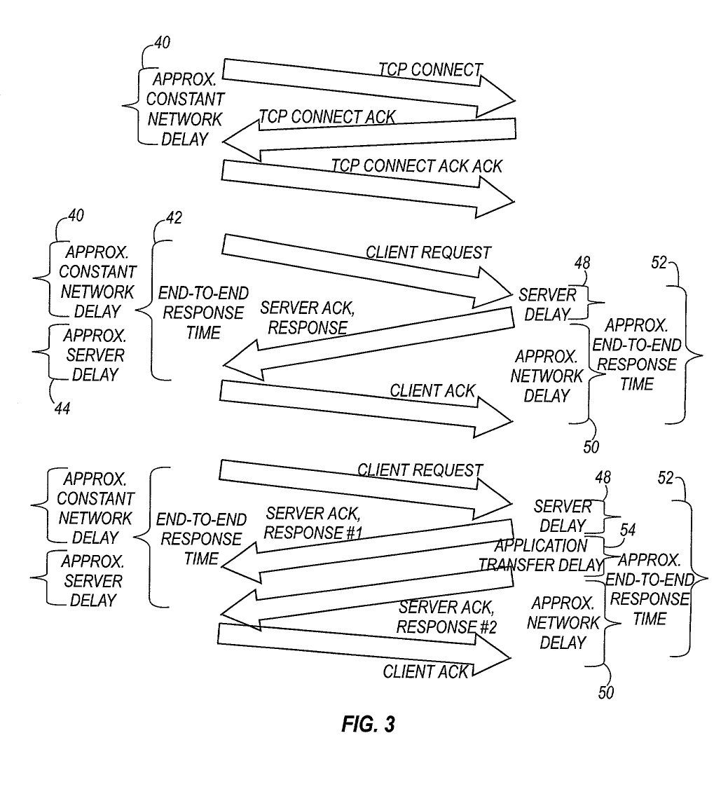

FIGS. 2 and 3 illustrate different techniques for computing packet-level response times for arbitrary TCP/IP applications (described below). FIG. 2 illustrates the network packet flow between a client 10 and a server 12. A client-site agent, such as client-site agent 24, is common in commercial applications. A server-site agent, such as server-site agent 26, optionally coupled with client-site agents, is the preferred methodology used with the present invention.

Following is a description of a client-site solution. A client-site passive agent is installed on or near a “typical” client. The client-site passive agent either decodes the packets (minimally to the transport layer and possibly to the application layer) or uses the ARM API to identify the beginning and end of an application transaction. With an agent on the client, accurate end-to-end response time statistics are computed (see numeral 42 in FIG. 3). This response time, however, includes both network and server delays. Approximations are used to separate the network delay from the server delay, as illustrated in FIG. 3.

A typical approximation of network delay uses the TCP session connect time (reference numeral 40 in FIG. 3), which frequently involves little server processing, as a constant network delay throughout the session. The difference between the measured packet response time 42 and the constant network delay 40 is attributed to the server (approximate server delay 44). This, method works reasonably well for applications with very short sessions (frequent TCP session connects to reestablish the network delay), but can be highly erroneous for longer sessions. Network delay variability even on small time-scales can be significant. For a single hop using FIFO service discipline, the network delay can range from 0 (no queue) to the product of the maximum router/switch buffer and the link speed.

Another approximation technique uses ICMP echo (ping) packets to estimate the network contribution. However, network devices may very well treat ICMP differently (e.g., different priority) than the actual application. The ICMP packet sizes probably are not representative of the actual application, and the pinging provides only a sampling of the network latency.

It is possible to improve the statistics by placing another client-side agent near the server and correlating the data between the two agents.

Following is a description of a server-site solution. A server-site passive agent is installed on/near a server. The server-site passive agent typically decodes the packets (minimally to the transport layer and possibly to the application layer) to identify the beginning and end of an application transaction. With the agent on the server, accurate server delay statistics are computed (reference numeral 48 in FIG. 3). The delay however does not include the network contribution. Approximations are used to compute the network delay. One approximation measures the time between server response to client acknowledgment to determine the network delay component 50. This server-client-server round-trip-time actually includes client acknowledgment processing, but this is typically negligible compared to the network delay in a WAN environment. Note that in this case the computed network delay is variable throughout the session—it is not assumed constant. A new network delay is computed for every observed client acknowledgement. Other methods for approximating network delay include use of the session setup time and application probe packets; these are useful for unreliable applications. As shown in FIG. 3, the end-to-end response time 52 can be approximated by adding the measured server delay 48 to the approximated network delay 50. In the case of multiple server response packets, the end-to-end response time 52 can be approximated by adding the measured server delay (Lower Bound) 48, the measured application transfer delay 54, and the approximated network delay 50.

Following is a comparison of the client-site and server-site solutions. In summary, the client-site passive agent should provide the most accurate end-to-end response time statistics but will have trouble separating the network and server delay components. It is more difficult to manage and maintain, as many agents must be deployed to various client sites. The view provided by a client-site agent is limited to the single client or client site.

The server-side passive agent should provide the most accurate server delay statistics but must approximate the network component. The network delay statistics (distribution, correlation) in the server-site agent can be more accurate than those of the client-site agent. The server-site agent also has a better “view” of the entire enterprise—many clients for the one agent. The server-site agent is also much easier to deploy and maintain.

Following is a more detailed description of an example of the present invention. A business-process transaction may consist of a number of smaller transactions which themselves may consist of a number of packet-level requests and responses. For example, a business-process transaction may be defined as the placing of a purchase order via the web. The purchase order may consist of several steps including the selection of items, the filling out of forms for billing and shipping, and the confirming of the order. Each step within the purchase-order transaction is itself a smaller transaction. No matter the size, each transaction consists of at least one packet-level request and response.

Because transactions can be defined in many different ways, the present invention uses a transaction decomposition/reconstruction method in its response time computation. The invention uses the packet-level algorithms described above to track response time information. The invention tracks the packet-level responses according to size of the response, application group, server group, and client group in order to reconstruct defined transactions through post-processing. The invention provides this packet-level response time information for arbitrary applications, and uses this packet-level response time information to reconstruct transaction response times for defined transactions. For well-known applications like HTTP, it computes HTTP transaction response times in addition to packet-level response times. The invention reconstructs meta-transactions from the HTTP transactions.

To summarize, pattern matching and protocol decodes will be used for well-known applications like HTTP to identify transaction components. The packet-level algorithms described above will be used for arbitrary reliable and unreliable applications. The network delay component will be estimated using continual innovations based on application acknowledgments for reliable applications and connection setup times in conjunction with application probes for unreliable applications. Response time measurements will be computed separately for each defined object (e.g., URL) and response size, allowing for a more realistic service level agreement (SLA) management device.

Following is a description of transaction decomposition and reconstruction used by the present invention. A transaction may be defined as a sequence of requests. The sequence may consist of both parallel and series requests that may or may not be piggybacked. For example, a sequence may consist of the following sequence:

1. Open session Z

2. Request web page, wait for response

3. Open three parallel TCP sessions A, B, and C

4. Session A: send 1 request, wait for response, close session A

5. Session B: send 1 request, wait for response, send another request, wait for response, close session B

6. Session C: send two requests back-to-back without waiting for a response between them, wait for both responses, close C

7. Close Session Z

This transaction may be modeled using the following expression:

OPEN+W_REQ-Z1+OPEN+max{W_REQ-A1, W_REQ-B1+W_REQ-B2, P_REQ-C1C2},

where OPEN is a random variable representing the session connection time, W_REQ-Z1 is a random variable representing the response time to download the web page, W_REQ-A1 is a random variable representing the response time for the Session A single request, W_REQ-B 1 is a random variable representing the response time for the Session B first request, W_REQ-B2 is a random variable representing the response time for the Session B second request, and P_REQ-C1C2 is a random variable representing the response time for the Session C piggy-backed requests. That is, piggy-backed requests are treated as a single request in which the client request arrives over a finite time duration rather than at a single time instance (T2 represents the arrival of the last packet, and the arrival time duration is added to the Total Response Time). The max operator selects the maximum time for completion of each of the three parallel sessions since the transaction is not complete until all sessions are complete. The session close commands are not represented since they do not impact the user experience directly.

The solution of the present invention computes the statistical functions for the OPEN (session connection times) random variable. It also computes the statistical functions for the W_REQ-Z1, W_REQ-A1, W_REQ-B1, W_REQ-B2 random variables, where the instances are based on the previously described packet-level algorithms (for arbitrary applications) and pattern matching/protocol decodes (for well-known applications). For piggybacked requests represented by the random variable P_REQ-C1C2, the invention employs a slightly modified algorithm: it computes a piggybacked packet-level (or transaction-level) response time rather than the normal individual packet-level (or transaction-level) response times. Thus the solution also computes the statistical functions for the piggybacked P_REQ-C1C2 random variables. The statistical functions for the random variants are operated on by the defining transaction expression to obtain the statistical function for the transaction response time random variable.

Any desired transaction is thus decomposed into a sequence of series and parallel individual or piggybacked (packet-level or transaction-level) requests and responses. A mathematical expression is derived (e.g., from packet traces) to reconstruct the desired transaction based on its components. A set of feasible components is identified by tracking response times on a server group, application group, client group, and object (e.g., response size for arbitrary applications) basis. A response time is associated with a feasible component of a transaction if it has an appropriate server group, application group, client group, and object type (e.g., URL for HTTP or response size for arbitrary unknown applications). Ensemble statistics are then formed for each feasible component. The mathematical expression defining the transaction is then applied to the ensemble statistics to form the transaction statistics.

The present invention is configurable to operate in client-site mode or server-site mode (or arbitrary-site mode) according to the algorithms described above. When installed at both the client site and the server site, the server-site box correlates the information to produce the most accurate results. In client-site mode, the invention measures the actual application connection setup time and pseudo-periodically sends application probes (e.g., TCP Connect requests) in order to get a good sampling of the network delay. This active-mode behavior should produce minimal distortion. In server-site mode, the invention uses the time between server responses to client acknowledgments to approximate network delay for reliable applications. As mentioned above, the estimation of network delay can be updated continuously as acknowledgments occur. The invention uses pseudo-periodically generated application pings to approximate network delay for unreliable applications. The present invention is designed for accuracy, scalability, and manageability of the solution.

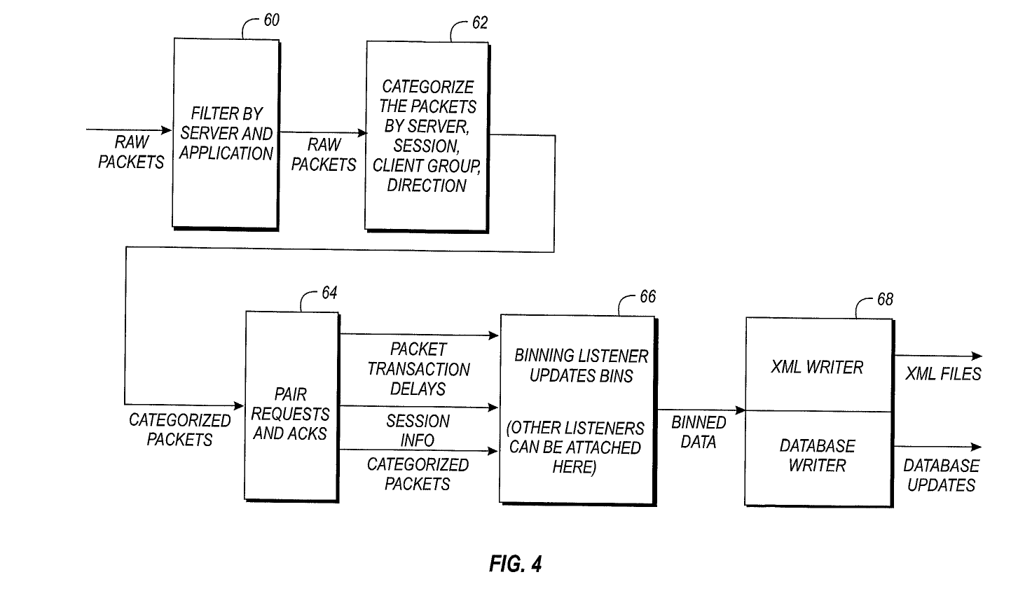

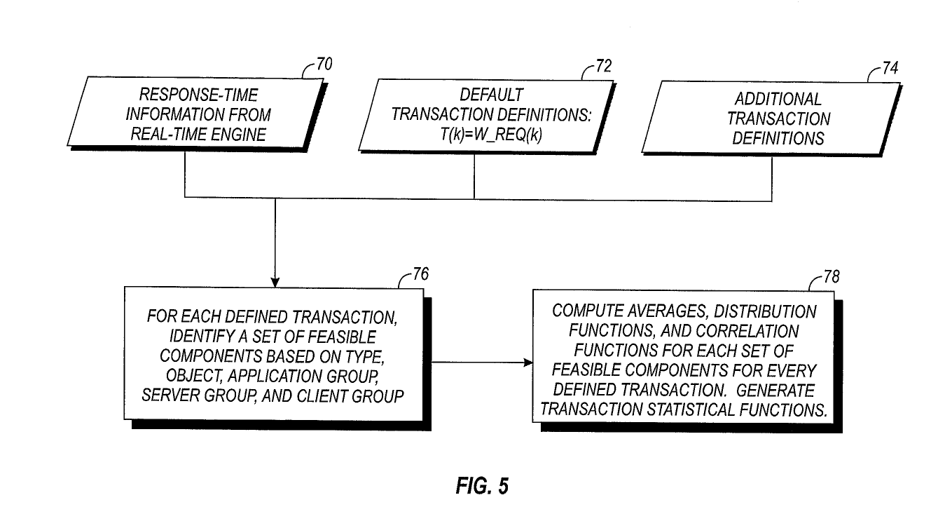

The solution of the present invention described above includes two modules: a real-time packet-level/transaction-level response time computation engine and a near-real-time post-processing transaction reconstruction engine. Alarm mechanisms are included in the real-time response-time computation engine while auto-threshold computation occurs in the reconstruction engine. The flow charts shown in FIGS. 4 and 5 illustrate the functionality of the two engines.

FIG. 4 is a flow chart illustrating the functionality of the real-time response-time computation engine. The flow chart of FIG. 4 diagrams the high level data flow of the computation engine. At the beginning of the flow chart, a filter block 60 filters the raw packets by server and application. For example, an application may be defined by TCP or UDP port number; the server may be inferred from the TCP or UDP port numbers, or it may be defined by IP address or address range. At a categorization block 62, the filtered raw packets are categorized by server, session, client group, and direction. Next, at block 64, the appropriate requests and acknowledgments are paired. Next, packet transaction delays, session information, and categorized packets are introduced to block 66 where a binning listener, and any other desired listeners, update bins. Finally, the binned data is introduced to block 68, where an XML writer generates XML files and a database writer provides database updates.

FIG. 5 is a flow chart illustrating the functionality of the near-real-time transaction reconstruction engine. The transaction reconstruction engine uses the data illustrated in FIG. 5 to identify feasible components and to make computations and generate statistical functions.

Block 70 represents response-time information from the real-time engine (described above). Block 72 represents default transaction definitions. The default transaction definitions are defined by the following equation:

T(k)=W_{—}REQ(k),

where k represents a response size range, T(k) is the transaction definition for response size range k, and W_REQ(k) is the random variable representing the response times for responses with size in the range specified by k. For example, let k=3 specify response sizes between 1481 and 1960 bytes. Then T(3)=W_REQ(3) indicates that all response times that have response sizes between 1481 and 1960 bytes are to be considered instances of the W_REQ(3) random variable. From the defining equation, the statistics for T(3) are identical to those for W_REQ(3). Block 74 represents additional transaction definitions. For each defined transaction, the invention creates a characterization of the transaction components (e.g., URLs or response-sizes) and request types (e.g., individual or piggybacked) with a mathematical formulation for the transaction showing how the transaction is constructed from its components.

For each defined transaction, the transaction reconstruction engine identifies a set of feasible components based on type of request (individual or piggybacked request), object (e.g., URL or response size), application group (e.g., Amazon Web Orders), server group (e.g., IP address range 192.23.48.31-192.23.48.33), and client group (e.g., IP address range 163.185.0.0-163.185.255.255). This is illustrated in block 76. The default transactions are defined as single packet-level responses with various response sizes for each application group, server group, and client group. Next, at block 78, the transaction reconstruction engine computes averages, distribution functions, and correlation functions for each set of feasible components for every defined transaction. The transaction reconstruction engine also uses the mathematical expression defining the transaction to generate the transaction statistical functions.

In summary, the present invention provides a process for monitoring response-time behavior of arbitrary applications using an agent located only at the server site (although agents may also be used at client or arbitrary sites via a minor alteration in algorithm). The network and server delay components are individually identified using continual innovations based on the actual application behavior. The invention distinguishes response time measurements and alarms based on the size of the response, allowing more intelligent alerting. For arbitrary applications the invention provides packet-level response times. For defined transactions, the invention decomposes the transaction into packet-level information then reconstructs the transaction response times from the packet-level response times. Following is a listing of some of the features of the present invention:

supports single-agent deployment near the server(s) where it can easily be managed, resulting in no need to deploy multiple agents at various client sites;

supports any arbitrary application, as opposed to being restricted to specific applications like HTTP or SQLNET (a protocol used for interfacing with a database);

supports encrypted applications where the transport header is consistent (e.g., supports HTTPS);

separates application delay into a network and server processing components based on the actual experience of the application—not based solely on artificial pseudo-periodical samples;

supports continual innovations to the network delay estimation—not just a single snapshot during session establishment;

distinguishes response time measurements and alarms based on the size of the response (e.g., the response time behavior of 100 MByte downloads can be obtained separately from and simultaneously to that for 100 KByte downloads);

supports transaction as well as packet-level response times for arbitrary applications using a reconstruction method; and

provides flow information for network planning and policy management—not just a Service Level Agreement (SLA) management tool.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of determining response times in a network without relying on client-site agents comprising the steps of:
providing a server-site agent;
measuring the server delay;
estimating the network delay; and
determining the response time of a client on the network based on the measured server delay and the estimated network delay.

2. The method of claim 1, wherein the network delay is estimated by measuring the amount of time between a server response and a client acknowledgment of the response.

3. The method of claim 2, wherein the network delay is continuously estimated.

4. The method of claim 2, wherein the network delay is estimated each time a client acknowledges a response from a server.

5. The method of claim 1, wherein the response times are determined using actual application packets.

6. The method of claim 5, wherein the response times are determined without the use of test packets.

7. The method of claim 1, wherein a plurality of response times are determined over time.

8. The method of claim 7, further comprising the step of distinguishing determined response times based on sizes of responses.

9. A server-site monitoring system for determining response-time behavior for arbitrary applications comprising:
a server-site agent, wherein the server-site agent performs the processing steps of,
determining application response times, and
separating determined response times into network delay components and server delay components.

10. The server-site monitoring system of claim 9, wherein the application response times are determined by estimating the network delay, determining the server delay, and estimating the total delay based on the network and server delays.

11. The server-site monitoring system of claim 9, wherein the application response times are determined without relying on client-site agents.

12. A method of determining response times in a WAN without requiring multiple agents comprising the steps of:
providing an agent somewhere on the WAN; and
for one or more transactions on the WAN, determining the end-to-end response time, the server delay, and the network delay.

13. The method of claim 12, wherein the agent is a server-site agent.

14. The method of claim 13, wherein the end-to-end response time is determined by the steps of:
measuring the server delay;
approximating the network delay; and
determining the end-to-end response time by adding the measured server delay to the approximated network delay.

15. The method of claim 12, wherein the agent is a client -site agent.

16. The method of claim 15, wherein the server delay is determined by the steps of:
measuring the end-to-end response time;
approximating the network delay; and
determining the server delay by subtracting the approximated network delay from the measured end-to-end response time.

17. The method of claim 12, wherein the agent is located along the client-server path.

18. A method of determining transaction-level response times in a network comprising the steps of:
for a transaction comprised of a plurality of individual components, tracking the response times of each of the individual components; and
determining the response time of the transaction by reconstructing the transaction using the tracked response times of the individual components.

19. The method of claim 18, further comprising the steps of:
deriving a mathematical expression representing the transaction; and
using the derived mathematical expression to reconstruct the transaction.

20. The method of claim 18, wherein the packet-level response times are determined by an agent installed on the network.

21. The method of claim 20, wherein the agent is a server-site agent.

22. The method of claim 20, wherein the agent is a client-site agent.

23. The method of claim 20, wherein the packet-level response times are determined by the agent, without relying on another agent on the network.

24. A method of determining the response time of a transaction in a network comprising the steps of:
deriving a mathematical expression to define a transaction that is comprised of a sequence of requests and responses;
determining packet-level response times of the sequence of requests and responses;
reconstructing the transaction based on the derived mathematical expression and the packet-level response times.

25. The method of claim 24, wherein the packet-level response times are tracked according to size.

26. The method of claim 24, wherein the packet-level response times are tracked according to application group.

27. The method of claim 24, wherein the packet-level response times are tracked according to server group.

28. The method of claim 24, wherein the packet-level response times are tracked according to client group.

29. The method of claim 24, further comprising the step of providing an agent to determine the response time of the transaction.

30. The method of claim 29, wherein the agent is a server-site agent.

31. The method of claim 30, wherein the server-site agent determines response times without relying on a client-site agent.

32. The method of claim 29, wherein the agent is a client-site agent.

33. A method of estimating a network delay in a network comprising the steps of:
(A) providing a server-site agent;
(B) determining the amount of time from when a server sends a response to a client, to when the server receives an acknowledgment back from the client;
(C) estimating the network delay based on the determined amount of time; and
(D) repeating steps (B) and (C) to improve the accuracy of estimation of the network delay where the network delay is not constant.

34. The method of claim 33, wherein steps (B) and (C) are repeated whenever an acknowledgment is received from the client.
